(19) United States
(12) Patent Application Publication
(10) Pub. No.: US 2006/0119104 A1
(43) Pub. Date: Jun. 8, 2006

(54) Portable wind up DC generator

(76) Inventor: Jerrold R. Wall, Albany, OR (US)

Correspondence Address: LITMAN LAW OFFICES, LTD, PO BOX 15035, CRYSTAL CITY STATION, ARLINGTON, VA, 22215, US

(21) Appl. No.: 11/005,323

(22) Filed: Dec. 7, 2004

(51) Int. Cl. F01K 15/00; F01K 17/02; F02C 6/18

(52) U.S. Cl. 290/2

(57) ABSTRACT

A portable wind up DC generator includes a housing with support elements and a carrying element. The housing may contain mounted therein and/or carried thereby a power input interface, a power output interface, a rechargeable battery, a wind up DC generator, a CPU, a memory, a removable flashlight, a light, a tape player, a CD player, a radio, a GPS receiver, and an antenna communicatively interconnected via a communication bus. The housing may also carry spare battery(s), a set of jumper cables; a portable tool, as well as any other utility items. The radio may receive AM, FM, marine band, shortwave, weather, aircraft, UHF, VHF, ham radio, or CB radio frequencies.

### BACKGROUND OF THE INVENTION

1. Field of the Invention

The present invention generally relates to power supply devices and, more particularly, to a portable wind up direct current (DC) generator.

2. Description of the Related Art

Portable power generation machines have been available for a significant period of time. Such portable power generation machines are typically used to provide power to external power consuming accessories and are powered using fuel and/or gaseous liquids, such as gasoline, diesel fuel, or propane. In addition, a variety of power consuming devices have been available that include integrally connected manually activated power generating means to enable users to manually power the integrally connected power consuming devices. Therefore a need exists for a wind up portable DC generator including a manually activated power generating means that can also provide power to external power consuming accessories.

The related art is represented by the following references of interest.

U.S. Patent Application Publication No. 2002/0067143 A1, published on Jun. 6, 2002 for Mark I. Robinett et al., describes a rechargeable portable light having a housing member with an opening for the emission of light, and several possible charging systems including a solar panel, an AC charger, an auto charger, and a hand crank generator charger. The Robinett et al. application does not suggest a portable wind up DC generator according to the claimed invention.

U.S. Patent Application Publication No. 2002/0070554 A1, published on Jun. 13, 2002 for Clifton G. Anderson, describes an apparatus for generating a constant source of electrical power in remote locations in the field for use while camping or hunting, in vehicles, on water craft, or for providing power during emergencies due to power failures, accidents, storms, or natural catastrophies. The Anderson application does not suggest a portable wind up DC generator according to the claimed invention.

U.S. Patent Application Publication No. 2002/0191417 A1, published on Dec. 19, 2002 for Kouji Suzuki et al., describes an engine-driven portable generator using an inverter that may still generate a voltage at its output terminals even though the engine is stopped. The Suzuki et al. application does not suggest a portable wind up DC generator according to the claimed invention.

U.S. Patent Application Publication No. 2003/0024566 A1, published on Feb. 6, 2003 for Phillip C. Watts, describes a combination outdoor portable heating pad and electricity generator. The Watts application does not suggest a portable wind up DC generator according to the claimed invention.

U.S. Pat. No. 4,057,736, issued on Nov. 8, 1977 to Morris R. Jeppson, describes an electrical power generation and distribution system. The Jeppson patent does not suggest a portable wind up DC generator according to the claimed invention.

U.S. Pat. No. 4,150,300, issued on Apr. 17, 1979 to Martin Van Winkle, describes an electrical and thermal energy supply system for buildings wherein electricity is generated by an engine driving a generator either inside or in close proximity to the building. The Van Winkle patent does not suggest a portable wind up DC generator according to the claimed invention.

U.S. Pat. No. 4,262,209, issued on Apr. 14, 1981 to Charles A. Berner, describes a supplemental electrical power generating system. The Berner patent does not suggest a portable wind up DC generator according to the claimed invention.

U.S. Pat. No. 4,332,006, issued on May 25, 1982 to Pil Y. Choe, describes a portable mechanical light generating device. The Choe patent does not suggest a portable wind up DC generator according to the claimed invention.

U.S. Pat. No. 4,360,860, issued on Nov. 23, 1982 to Hugh G. Johnson et al., describes a unitary portable flashlight assembly incorporating a hand operated generator and rechargeable batteries. The Johnson et al. patent does not suggest a portable wind up DC generator according to the claimed invention.

U.S. Pat. No. 5,187,386, issued on Feb. 16, 1993 to Shuen-Chin Chang et al., describes an intermediate DC voltage generator that provides low standby current. The Chang et al. patent does not suggest a portable wind up DC generator according to the claimed invention.

U.S. Pat. No. 5,568,370, issued on Oct. 22, 1996 to Leonard Goldstein et al., describes a tactical power adapter which adapts power from worldwide power sources and supplies the power to a plurality of electronic devices. The Goldstein et al. patent does not suggest a portable wind up DC generator according to the claimed invention.

U.S. Pat. No. 5,590,741, issued on Jan. 7, 1997 to Wayne W. Storms, describes a spring motor having a large number of flat spiral wound springs connected in series which allows storage of large amounts of energy in a small amount of cubic space. The Storms patent does not suggest a portable wind up DC generator according to the claimed invention.

U.S. Pat. No. 5,653,523, issued on Aug. 5, 1997 to Thomas J. Roberts, describes a miniaturized lighting apparatus for a rotating object that includes an LED, a centrifugal switch, a three volt power source, and electrical conduits. The Roberts patent does not suggest a portable wind up DC generator according to the claimed invention.

U.S. Pat. No. 5,751,564, issued on May 12, 1998 to Ghing-Hsin Dien, describes a switching power supply system which is able to connect two or more different power sources with different voltage levels, and can provide uninterrupted power even when the primary power source is low or absent. The Dien patent does not suggest a portable wind up DC generator according to the claimed invention.

U.S. Pat. No. 5,781,422, issued on Jul. 14, 1998 to James V. Lavin et al., describes an uninterruptible power supply which includes first and second inputs for receiving AC and DC power respectively, first and second switching circuits, an auxiliary power supply, a transformer, a selection circuit, an AC to DC converter, and a hold-up capacitor. The Lavin et al. patent does not suggest a portable wind up DC generator according to the claimed invention.

U.S. Pat. No. 5,880,532, issued on Mar. 9, 1999 to Robert D. Stopher, describes a spring motor which is coupled to a generator through a gear mechanism to provide portable and reusable supply of electric power. The Stopher patent does not suggest a portable wind up DC generator according to the claimed invention.

U.S. Pat. No. 5,917,310, issued on Jun. 29, 1999 to Trevor Baylis, describes a generator device which provides a controlled electric output current to a load. The Baylis patent does not suggest a portable wind up DC generator according to the claimed invention.

U.S. Pat. Nos. 5,929,611 and 6,034,511, issued on Jul. 27, 1999 and Mar. 7, 2000, respectively, to Harold C. Scott et al., describe a light weight engine-driven generator set including a rotor and a with multiple coil windings in thermal contact. The Scott et al. patents do not suggest a portable wind up DC generator according to the claimed invention.

U.S. Pat. No. 5,931,245, issued on Aug. 3, 1999 to Akihito Uetake et al., describes a battery control system for an electric vehicle. The Uetake et al. patent does not suggest a portable wind up DC generator according to the claimed invention.

U.S. Pat. No. 5,977,684, issued on Nov. 2, 1999 to Ted T. Lin, describes a rotating machine configurable as a pure DC generator for use in various applications. The Lin patent does not suggest a portable wind up DC generator according to the claimed invention.

U.S. Pat. No. 5,982,577, issued on Nov. 9, 1999 to Paul Brown et al., describes a batteryless, spring-powered portable cassette player. The Brown et al. patent does not suggest a portable wind up DC generator according to the claimed invention.

U.S. Pat. No. 5,998,975, issued on Dec. 7, 1999 to Masahiro Tada et al., describes an electric power supplying apparatus. The Tada et al. patent does not suggest a portable wind up DC generator according to the claimed invention.

U.S. Pat. No. 6,094,629, issued on Jul. 25, 2000 to Mark L. Grabb et al., describes a speech coding system and method. The Grabb et al. patent does not suggest a portable wind up DC generator according to the claimed invention.

U.S. Pat. No. 6,098,175, issued on Aug. 1, 2000 to Howard Hong-Dough Lee, describes an energy conserving power supply system that utilizes a keep alive DC power to consistently power a control circuit so as to render a main power supply readily actuatable for either distributing AC power or supplying regulated DC power. The Lee patent does not suggest a portable wind up DC generator according to the claimed invention.

U.S. Pat. No. 6,220,719 B1, issued on Apr. 24, 2001 to Steven R. Vetorino et al., describes a renewable energy flashlight with a housing and a barrel located within the housing. The Vetorino et al. patent does not suggest a portable wind up DC generator according to the claimed invention.

U.S. Pat. No. 6,266,261 B1, issued on Jul. 24, 2001 to Thomas W. Lanni, describes a DC powered adapter system. The Lanni. patent does not suggest a portable wind up DC generator according to the claimed invention.

U.S. Pat. No. 6,271,731 B2, issued on Aug. 7, 2001 to Christopher R. Koszarksy, describes a control circuit for a programmable frequency synthesizer. The Koszarsky patent does not suggest a portable wind up DC generator according to the claimed invention.

U.S. Pat. No. 6,291,900 B1, issued on Sep. 18, 2001 to Jerome J. Tiemann et al., describes a manually powered apparatus which includes a mechanical energy input device that releases mechanical energy. The Tiemann et al. patent does not suggest a portable wind up DC generator according to the claimed invention.

U.S. Pat. No. 6,293,771 B1, issued on Sep. 25, 2001 to Paul S. Haney et al., describes an apparatus including a manually operable air pump for providing a compressed flow of air to an air motor. The air motor is coupled to an electrical generator that provides electrical power to a portable electrical device. The Haney et al. patent does not suggest a portable wind up DC generator according to the claimed invention.

U.S. Pat. No. 6,322,233 B1, issued on Nov. 27, 2001 to Paul K. Brandt, describes an emergency flashlight with generating means in a rotary portion of the flashlight interconnected with a light-producing means mounted on an elongate swing shaft of the flashlight. The Brandt patent does not suggest a portable wind up DC generator according to the claimed invention.

U.S. Pat. No. 6,472,846 B1, issued on Oct. 29, 2002 to John E. Hutchinson et al., describes a power system with a generator and a rechargeable electrical storage device connectable to a load that is configured such that when energy output by the generator is in excess of the power requirement of the load the excess power is used to charge the battery. The Hutchinson et al. patent does not suggest a portable wind up DC generator according to the claimed invention.

U.S. Pat. No. 6,523,646 B1, issued on Feb. 25, 2003 to Glenn A. Gates, describes a spring driven apparatus for generating useful power. The Gates patent does not suggest a portable wind up DC generator according to the claimed invention.

Great Britain Patent Application Publication No. GB 2 299 457 A, published on Oct. 2, 1996, describes a portable power supply which uses manual energy to be converted into electrical energy. The Great Britain '457 application does not suggest a portable wind up DC generator according to the claimed invention.

Japan Patent Application Publication No. 8-7932, published on Jan. 12, 1996, describes a cell pack with an AC plug that can be commonly used for charging and discharging. The Japan '932 application does not suggest a portable wind up DC generator according to the claimed invention.

Germany Patent Application Publication No. DE 196 11 816 A1, published on Oct. 2, 1997, describes a portable device for current generation for supplying small electrical devices. The Germany '816 application does not suggest a portable wind up DC generator according to the claimed invention.

Great Britain Patent Application Publication No. GB 2 312 999 A, published on Nov. 12, 1997, describes a portable power supply. The Great Britain '999 application does not suggest a portable wind up DC generator according to the claimed invention.

World Intellectual Property Organization (WIPO) Patent Application Publication No. WO 98/05900, published on Feb. 12, 1998, describes a spring-driven power source for a low voltage electrical load. The WIPO '900 application does not suggest a portable wind up DC generator according to the claimed invention.

Japan Patent Application Publication No. 11-205916, published on Jul. 30, 1999, describes an electric vehicle which can extend its range and improve driving performance by using. The Japan '916 application does not suggest a portable wind up DC generator according to the claimed invention.

Japan Patent Application Publication No. 11-234907, published on Aug. 27, 1999, describes a DC/AC power supply which permits the power savings and effective utilization of a commercial power. The Japan '907 application does not suggest a portable wind up DC generator according to the claimed invention.

Japan Patent Application Publication No. 2001-69686, published on Mar. 16, 2001, describes a portable charger which carries solar batteries. The Japan '686 application does not suggest a portable wind up DC generator according to the claimed invention.

Japan Patent Application Publication No. 2001-78453, published on Mar. 23, 2001, describes a DC power supply. The Japan '453 application does not suggest a portable wind up DC generator according to the claimed invention.

WIPO Patent Application Publication No. WO 01/31764 A1, published on May 3, 2001, describes a portable manual generator. The WIPO '764 application does not suggest a portable wind up DC generator according to the claimed invention.

European Patent Application Publication No. EP 1 244 204 A1, published on Sep. 25, 2002, describes a portable generator for generating a single-phase AC voltage under pulse width modulator control that is subject to output voltage fluctuations under a heavy load. The European '204 application does not suggest a portable wind up DC generator according to the claimed invention.

WIPO Patent Application Publication No. WO 03/005533 A1, published on Jan. 16, 2003, describes an electric power supply device driven by a spring operated motor for portable telephones and computers. The WIPO '533 application does not suggest a portable wind up DC generator according to the claimed invention.

None of the above inventions and patents, taken either singly or in combination, is seen to describe the instant invention as claimed. Thus a portable wind up DC generator solving the aforementioned problems is desired.

### SUMMARY OF THE INVENTION

The present invention is a portable wind up DC generator. The DC generator includes a housing with support elements and a carrying element. The housing may contain mounted therein and/or carried thereby a power input interface, a power output interface, a rechargeable battery, a DC generator, a central processing unit (CPU), a memory, a removable flashlight, a light, a tape player, a compact disc (CD) player, a radio, a global positioning system (GPS) receiver, and an antenna communicatively interconnected via a communication bus. The housing may also carry one or more removable batteries, a set of jumper cables, a portable tool, as well as any other utility items.

Accordingly, it is a principal aspect of the invention to provide a portable wind up DC generator including a housing with support elements and a carrying element, a power input interface, a power output interface, a rechargeable battery, a DC generator, a CPU, a memory, and a communication bus communicatively interconnecting the power input interface, power output interface, rechargeable battery, wind up DC generator, CPU, and memory.

It is another aspect of the invention to provide a portable wind up DC generator a portable wind up DC generator including a housing with support elements and a carrying element, a power input interface, a power output interface, a rechargeable battery, a DC generator, a CPU, a memory, a removable flashlight, a light, a tape player, a CD player, a radio, a GPS receiver, at least one speaker, and an antenna and a communication bus communicatively interconnecting the power input interface, power output interface, rechargeable battery, wind up DC generator, CPU, memory, removable flashlight, light, tape player, CD player, radio, GPS receiver, at least one speaker, and antenna.

It is an aspect of the invention to provide improved elements and arrangements thereof in a portable windup DC generator for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a right perspective view of a portable wind up DC generator according to the present invention.

FIG. 2 is a left perspective view of the portable wind up DC generator shown in FIG. 1.

FIG. 3 is a block diagram of the portable wind up DC generator shown in FIG. 1.

Similar reference characters denote corresponding features consistently throughout the attached drawings.

### DETAILED DESCRIPTION OF THE PREFERRED EMBODIMENTS

The present invention is a portable wind up DC generator. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

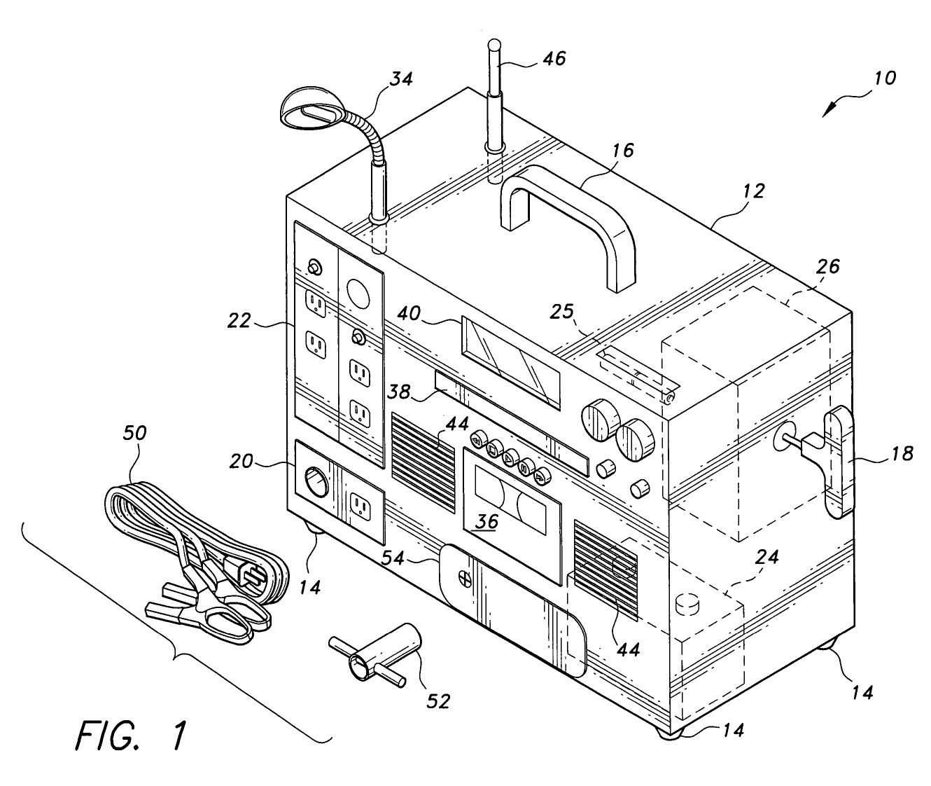

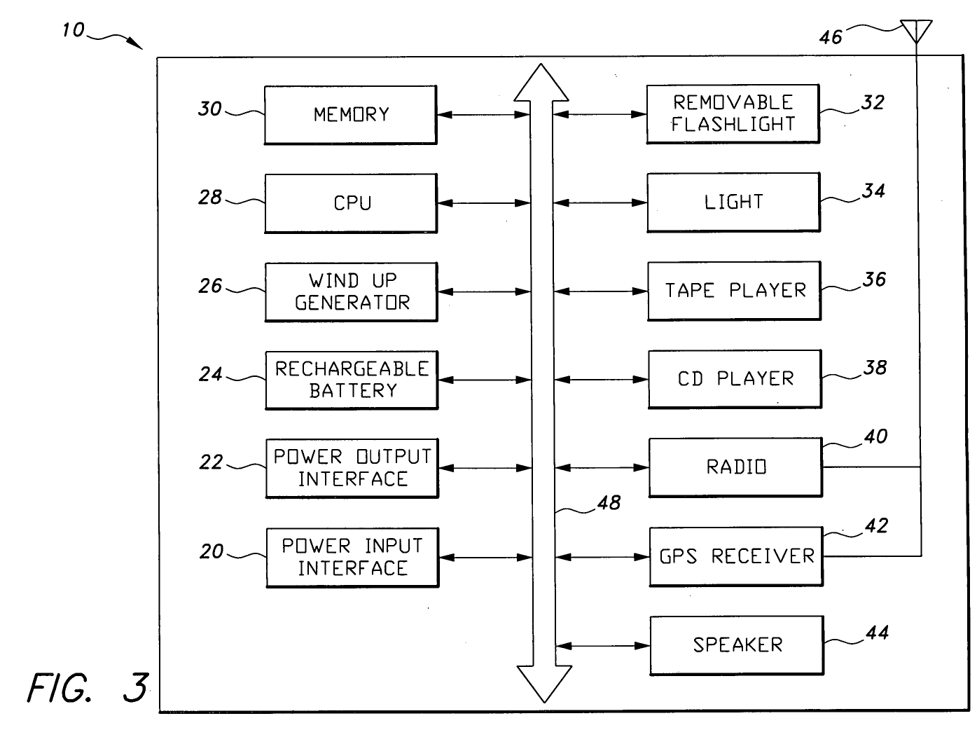

Referring to the drawings, FIGS. 1-3 show a portable wind up DC generator 10 according to the invention. The wind up DC generator 10 includes a housing 12 with support elements 14 and a carrying handle 16. The housing 12 may contain mounted therein and/or carried thereby a power input interface 20, a power output interface 22, a rechargeable battery 24, a DC generator 26, a CPU 28, a memory 30, a removable flashlight 32, a light 34, a tape player 36, a CD player 38, a radio 40, a GPS receiver 42, speaker(s) 44, and an antenna 46 communicatively interconnected via a communication bus 48. The housing may also carry one or more removable batteries 25, a set of jumper cables 50, and a portable tool 54, as well as any other utility items (e.g., flares, a first aid kit, elastic tie-down cords, rope, etc.).

The housing 12 may be configured in a form suitable for enabling a user to easily pick up and carry the portable DC generator, such as in the form of a rectangular case, and may be made from durable material according to the desires of the user, such as polycarbonate, plastic, metal, or the like. The housing 12 may include a plurality of buttons and/or switches configured to enable a user to activate/deactivate accessories contained therein.

The power input interface 20 is configured to receive external AC and/or DC power from external AC and/or DC power sources. Such external power sources may be any of a variety, such as a vehicle battery, a utility outlet, or the like. The power input interface 20 may include AC and/or DC power input jacks configured for interconnecting external AC and/or DC power sources, an AC/DC converter, a DC/AC converter, and other associated power input interface circuitry. External AC power may used to power external AC accessories, external and/or internal DC accessories, and/or charge the internal rechargeable battery via the AC/DC converter. External DC power may be used to power external AC accessories interconnected with and the power output interface 22 via the DC/AC converter, and may be used to power external and/or internal DC accessories, and/or charge the internal rechargeable battery.

The power output interface 22 is configured to enable external AC and/or DC accessories to be powered by power stored in the rechargeable battery, provided from an external power source, and/or developed from the DC generator 26 during and/or after wind up of the DC generator 26. The power output interface 22 may include one or more DC outlet jacks and one or more AC outlet jacks configured for interconnecting corresponding external DC and/or AC accessories (e.g., such as a cell phone, etc.), an AC/DC converter, a DC/AC converter, and other associated power output interface circuitry. The power output interface 22 may also include a DC reset on/off switch and an AC reset switch. DC power may be provided to the power output interface by any combination of power stored in the rechargeable battery, provided from an external power source, and/or developed from the DC generator 26 during and/or after wind up of the spring. The power output interface 22 may provide output DC power at desired DC power levels, according to the desires of the user, such as 3 volts, 5 volts, 10 volts, 12 volts, or the like. The power output interface 22 may also provide output AC power at desired AC power levels according to the desires of the user via a DC/AC converter.

The rechargeable battery 24 is configured to provide DC power for powering external and/or internal DC devices, and/or external AC accessories interconnected with the power output interface via the DC/AC converter. The rechargeable battery 24 is also configured to be charged to a predetermined power level by receiving power from an external AC power source interconnected with the power input interface via the AC/DC converter, an external DC power source interconnected with the power input interface 20, and/or the DC generator 26. The rechargeable battery 24 may be any type of rechargeable battery, such as a nickel cadmium battery, a metal hydride battery, or the like, and may charged to a predetermined amount according to the desires of the user. One or more removable rechargeable and/or non-rechargeable batteries 25 of any conventional size, such as A, AA, AAA, C, D, etc., may also be stored in a storage portion of the housing 12.

The DC generator 26 is interconnected with a wind up handle 18 via a cord, a wind up spring, and appropriate wind up gearing. The DC generator 26 may also include a pawl to prevent the wind up gearing from reversing. The wind up handle 18 is configured to enable a user to turn the wind up spring, such as a coil spring or the like, and store mechanical energy for driving the DC generator 26. The amount of energy that may be stored by the wind up spring depends on the number of times the wind up handle is pulled by a user, and may vary over a range from minutes to hours. The wind up gearing may include a gear train and a flywheel. The DC generator 26 is driven when the wind up spring unwinds through the windup gearing. The DC generator 26 converts the force stored by the wind up spring into outgoing DC power, and provides the outgoing DC power to the power output interface 20, the rechargeable battery 24, any internal accessories, and/or any externally accessories attached to the power output interface 20.

The CPU 28 is configured to process instructions received from application programs stored in the memory, and process data received from any interconnected and/or internal power sources, powered accessories and/or the DC generator 26. The CPU 28 may be any type of integrated processing device according to the desires of the user. The memory 30 may be removable and/or non-removable, and may include any combination of read only memory, random access memory, non-volatile read/write memory, etc. For example, the memory 30 may be a disk, electrically eraseable and programmable read only memory (EEPROM), flash memory, or the like.

The removable flashlight 32 is configured to enable a user to retrieve the flashlight 32 and use the flashlight 32 at a location remote from the housing 12 of the wind-up DC generator 10. The removable flashlight 32 includes a power source and a light source. The power source of the flashlight 32 may be rechargeable or non-rechargeable batteries. The flashlight 32 and the housing 12 may also be configured to allow the flashlight to be powered by the rechargeable battery 24 or the generator 26 when the flashlight 32 is stored within the housing 12.

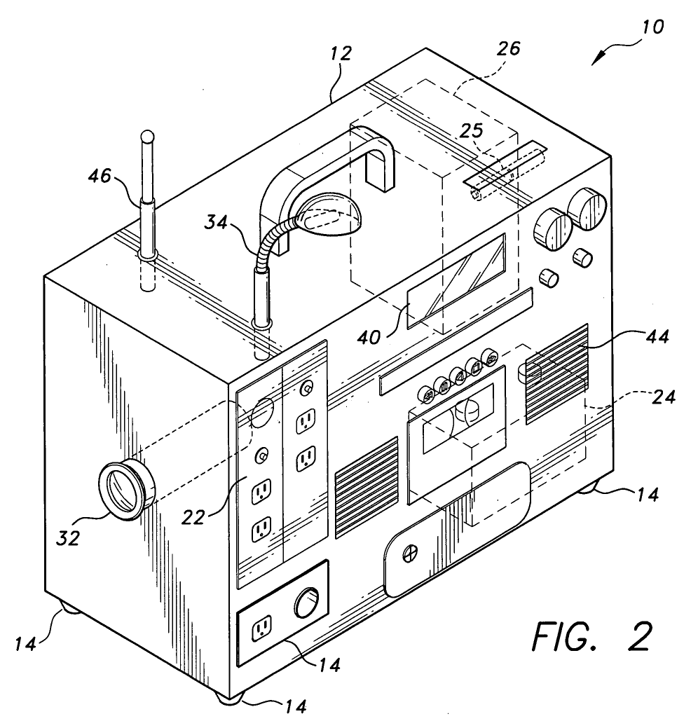

As illustrated in FIG. 2, the flashlight 32 is preferably releasably received in a generally elongate sleeve mounted in the side of the housing 12 opposite the side of the housing 12 where the handle 18 of the generator 26 is located. The sleeve may be made from flexible material, such as rubber or the like, to grasp the flashlight 32 in a biased manner. However, the flashlight 32 may be releasably received in another manner with any storage area configured in the housing 12 as desired. The light source of the flashlight 32 may be any type of light source, such as an incandescent light, a light emitting diode, or the like.

The light 34 is configured to illuminate an area near the housing 12 of the wind up DC generator 10. The light 34 includes a flexible member from which the light may be positionally adjusted. The light 34 also includes a cover to aesthetically direct illuminated light in a particular direction. The light 34 may also be telescopically received within the housing 12.

The tape player 36 is configured for playing a cassette tape and includes a cassette holder or cassette slot for inserting a cassette tape, and tape controls. The tape controls include buttons for REWIND, STOP, PLAY, PAUSE, and FAST FORWARD. Audio from a cassette tape may be heard through speakers mounted in the housing 12 or through headphones interconnected with the housing 12.

The CD player 38 includes CD controls, a holder or slot into which a CD may be inserted, and is configured to play a CD and includes a CD holder or CD slot into which a CD may be inserted. Audio from the CD player 38 may be heard through the speakers 44 mounted in the DC generator housing or through headphones interconnected with the DC generator housing.

The radio 40 includes radio receiver circuitry, a tuning display, and radio controls. The radio receiver circuitry is configured to operably receive frequencies selected by the user. Such frequencies may include AM, FM, marine band, shortwave, weather, aircraft, UHF, VHF, ham radio, CB radio, or any other frequencies as desired.

The radio controls include controls for power, tuning, and volume. Optional radio controls may include station search, station seek, and stereo balance. Audio from the radio 40 may be heard through the speakers 44 mounted in the housing 12 of the wind up DC generator 10 or through headphones interconnected with housing 12 of the wind up the DC generator 10. The antenna 46 for the radio may be telescopically mounted in the housing 12.

The GPS receiver 42 is configured to receive GPS signals from a plurality of satellites. The GPS receiver 42 analyzes received GPS signals to determine the GPS receiver's location or coordinate values. While the receiver is referred to as a GPS receiver, any other positioning receiver may alternatively be utilized in the portable DC generator, such as a Global Navigational System (GLONASS) receiver. GPS coordinate values of the location of the GPS receiver 42 may be displayed on the tuning display of the radio 40.

The housing 12 of the wind up DC generator housing 10 also includes a container with a removable cover 54 which may be fastened to the housing 12 by the use of any type of fastener. The container may be used to store utility items such as battery jumper cables 50, tools 52, or the like (e.g., flares, a first aid kit, elastic tie-down cords, rope, etc.).

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. A portable wind up DC generator comprising:
a housing with support elements and a carrying element;
a power input interface;
a power output interface;
a rechargeable battery;
a DC generator;
a central processing unit (CPU);
a memory; and
a communication bus communicatively interconnecting the power input interface, power output interface, rechargeable battery, wind up DC generator, CPU, and memory.

2. The portable wind up DC generator according to claim 1, wherein said housing is configured to enable a user to easily pick up and carry the portable wind up DC generator, and the housing includes a plurality of buttons/switches configured to enable a user to activate/deactivate accessories contained therein.

3. The portable wind up DC generator according to claim 1, wherein said power input interface is configured to receive external AC/DC power from external AC/DC power sources.

4. The portable wind up DC generator according to claim 3, wherein said power input interface comprises:
AC power input jacks configured to interconnect external AC power sources;
DC power input jacks configured to interconnect external DC power sources;
an AC/DC converter; and
a DC/AC converter;
whereby external AC power powers external AC accessories, external/internal DC accessories, and charges the internal rechargeable battery via the AC/DC converter, and whereby external DC power powers external AC accessories interconnected with and the power output interface via the DC/AC converter, and powers external/internal DC accessories, and charges the internal rechargeable battery.

5. The portable wind up DC generator according to claim 1, wherein said power output interface is configured to enable external AC/DC accessories to be powered by power stored in the rechargeable battery, by power provided from an external power source, and by power developed from the DC generator after wind up of the DC generator.

6. The portable wind up DC generator according to claim 5, wherein said power output interface comprises:
at least one DC outlet jack configured for interconnecting corresponding external DC and/or AC accessories;
at least one AC outlet jack configured for interconnecting corresponding external DC and/or AC accessories, an AC/DC converter, a DC/AC converter, and other associated power output interface circuitry;
a DC reset on/off switch; and
an AC reset switch;
whereby said power output interface provides output DC power at desired DC power levels.

7. The portable wind up DC generator according to claim 5, wherein said rechargeable battery is configured to provide DC power for powering external/internal DC devices, and external AC accessories interconnected with the power output interface via an DC/AC converter, and the rechargeable battery is configured to be charged to a predetermined power level by receiving power from an external AC power source interconnected with the power input interface via the AC/DC converter, an external DC power source interconnected with the power input interface, and the DC generator.

8. The portable wind up DC generator according to claim 1, wherein said DC generator is interconnected with a wind up handle via a cord, a wind up spring, and wind up gearing, is driven when the wind up spring unwinds through the windup gearing, and converts force stored by the wind up spring into outgoing DC power, and provides the outgoing DC power to the power output interface, the rechargeable battery, any internal accessories, and any externally accessories attached to the power output interface.

9. The portable wind up DC generator according to claim 1, wherein said CPU is configured to process instructions received from application programs stored in the memory, and process data received from any interconnected/internal power sources, powered accessories, and the DC generator.

10. The portable wind up DC generator according to claim 1, wherein said memory includes any combination of read only memory, random access memory, and non-volatile read/write memory.

11. The portable wind up DC generator according to claim 1, further comprising:
a removable flashlight;
a light;
a tape player;
a compact disc (CD) player;
a radio;
a global positioning system (GPS) receiver;
at least one speaker; and
an antenna,
whereby the removable flashlight, light, tape player, CD player, radio, GPS receiver, at least one speaker, and antenna are communicatively interconnected with the communication bus.

12. The portable wind up DC generator according to claim 11, wherein said removable flashlight is configured to enable a user to retrieve the flashlight and use the flashlight at a location remote from the housing of the DC generator.

13. The portable wind up DC generator according to claim 11, wherein said light comprises:
a flexible member to positionally adjust the light; and
a cover to aesthetically direct illuminated light in a particular direction,
whereby said light is configured to illuminate an area near the housing of the portable windup DC generator.

14. The portable wind up DC generator according to claim 11, wherein said tape player comprises tape controls and a tape holder/slot, said tape player being configured to play a cassette tape.

15. The portable wind up DC generator according to claim 14, wherein said tape controls comprise buttons for REWIND, STOP, PLAY, PAUSE, and FAST FORWARD.

16. The portable wind up DC generator according to claim 11, wherein said CD player comprises CD controls and a CD holder/slot, said CD player being configured to play a CD.

17. The portable wind up DC generator according to claim 11, wherein said radio includes radio receiver circuitry, a tuning display, and radio controls, said radio being configured to receive and play radio signals.

18. The portable wind up DC generator according to claim 17, wherein said radio receiver circuitry is configured to receive AM, FM, marine band, shortwave, weather, aircraft, UHF, VHF, ham radio, or CB radio frequencies.

19. The portable wind up DC generator according to claim 11, wherein said housing comprises a container with a removable cover fastenable to the housing by any type of fastener, said container being configured to store utility items.

20. The portable wind up DC generator according to claim 19, wherein said utility items include battery jumper cables and tools.
